(19) United States
(12) Patent Application Publication
(10) Pub. No.: US 2022/0376923 A1
(43) Pub. Date: Nov. 24, 2022

(54) MESSAGE AUTHENTICATION

(71) Applicant: Illinois at Singapore Pte Ltd, Singapore (SG)

(72) Inventors: Ertem ESINER, Singapore (SG); Binbin CHEN, Singapore (SG); Daisuke MASHIMA, Singapore (SG); David M. NICOL, Singapore (SG); Zbigniew KALBARCZYK, Singapore (SG); Utku TEFEK, Singapore (SG)

(21) Appl. No.: 17/769,980

(22) PCT Filed: Oct. 16, 2020
(86) PCT No.: PCT/SG2020/050591

§ 371 Date: Apr. 18, 2022

(30) Foreign Application Priority Data
Oct. 18, 2019 (SG) 10201909762U

(51) Int. Cl. H04L 9/32; H04L 9/08; H04L 9/00

(52) U.S. Cl. CPC H04L 9/3242; H04L 9/3247; H04L 9/0825; H04L 9/50

(57) ABSTRACT

Disclosed herein is a method of provisioning a message authentication protocol in a system of connected devices, the method comprising, by at least one of the connected devices: generating a private key and a public key; transmitting the public key to each other connected device; generating, by a sequence of hash operations using the private key, a hash tree, wherein each leaf node of the hash tree can have two or more values, each of the two or more values being associated with a respective nonce value, and wherein each leaf node has a hash computed from the concatenation of the respective nonce values; signing a root of the hash tree with the private key; and transmitting the root and the root signature to each other connected device.

### TECHNICAL FIELD

The present disclosure relates generally to the field of cybersecurity, for example in the context of smart grid systems and other Internet of Things (IoT) systems.

### BACKGROUND

Multicast message authentication for time stringent systems is a challenging problem. Not only are source authentication and validating message integrity already challenging when multiple destinations are considered, but they also need to be achieved in a time-stringent environment.

One known method of multi-cast message authentication is using digital signatures. For instance, in the IEC standards (IEC 62351-6), the use of RSA is suggested for IEC 61850 GOOSE (Generic Object Oriented Substation Event) authentication, where the maximum end-to-end delay should be under 4 ms. However, schemes based on public key cryptography depend on computationally expensive operations such as modular exponentiation. Even for RSA signatures on their own to fit within this 4 ms budget, expensive dedicated hardware is required, let alone to achieve an overall processing budget of under 4 ms. It has been shown that even an FPGA implementation of RSA signatures is not feasible when the end-to-end delay requirement is less than 4 ms.

Some solutions have been able to achieve fast response times in certain narrowly defined situations, such as by exploiting existing structure in command and control messages.

However, achieving such response times more generally remains challenging, for example when legacy compliance is desired. In the absence of a hardware budget constraint, the best candidate from the public key cryptography domain would be ECDSA (the elliptic curve digital signature algorithm).

Apart from public key cryptography, some symmetric key based solutions are also known. These solutions rely on keyed-hash message authentication codes (HMAC). These functions are computationally efficient, however, these schemes are missing some essential features such as simple key distribution and public verification (for non-repudiation). Additionally, when there are more than a threshold of destinations for the message, group key implementations are required. These are vulnerable against untrusted destinations, since they are open to impersonation attacks.

Another known solution for multi-cast authentication uses one-time signatures (OTS), such as Lamport or Rabin. Originally this required huge asymmetric keys and signature sizes. More efficient schemes have since been proposed. These schemes are fast in terms of computational efficiency, and they are publicly verifiable; however, these schemes have a limitation in that every public/private key pair can be used only once, and then they need to be refreshed.

Some alternatives are delayed key disclosure schemes and signature amortization schemes. The former method requires the destination to buffer the messages until the authentication key is released by the source, therefore lacks immediate verification. The latter requires the destination to assemble all the messages in a group before verifying their collective signature, thus it also lacks immediate verification and is vulnerable against packet loss.

### SUMMARY

A first aspect of the present disclosure relates to a method of provisioning a message authentication protocol in a system of connected devices, the method comprising, by at least one of the connected devices:
generating a private key and a public key;
transmitting the public key to each other connected device;
generating, by a sequence of hash operations using the private key, a hash tree, wherein each leaf node of the hash tree can have two or more values, each of the two or more values being associated with a respective nonce value, and wherein each leaf node has a hash computed from the concatenation of the respective nonce values;
signing a root of the hash tree with the private key; and
transmitting the root and the root signature to each other connected device.

The method may further comprise each other connected device validating the root signature.

In some embodiments, each leaf node of the hash tree can have three values, wherein each of the three values comprises a nonce corresponding to 0, 1, and a break value.

In some embodiments, the method is repeated after consumption of a predetermined number of the nonce values, and/or before a predetermined expiry time.

A second aspect of the present disclosure relates to a method of providing authentication information for a message in a system of connected devices, the method comprising:

at one of the connected devices that stores a hash tree in which each leaf node can have two or more values, each of the two or more values being associated with a respective nonce value that is stored in association with the hash tree, each leaf node having a hash computed from the concatenation of the hashes of the respective nonce values:
determining an offset of a leaf node which has not already been used;
determining a symbol sequence of the message, each symbol in the sequence having one of said two or more values;
determining a proof by:
   for each symbol in the sequence, retrieving a corresponding nonce value of a corresponding leaf node based on the value of the symbol, and hashes of the other respective nonce values for the corresponding leaf node; and
   traversing the hash tree to retrieve hashes of siblings of nodes on a path between the leaf node and a root of the hash tree;
   wherein the proof comprises a combination of, for the respective symbols, the corresponding nonce values, the hashes of the other respective nonce values, and the hashes of the siblings on the path between the leaf node and the root; and
   transmitting the proof and the message to at least one of the other connected devices.

In some embodiments, the message begins and ends with a break symbol.

In some embodiments, the hash tree is generated by a method according to the first aspect of the present disclosure.

In a third aspect, the present disclosure relates to a method of verifying authentication information for a message in a system of connected devices, the method comprising:

at a connected device of the connected devices, receiving the message and a proof from another device of the connected devices, the proof being generated according to a hash tree;
retrieving a root and a root signature for the another device; and
verifying the proof by:
   determining a sequence of symbols of the message;
   determining, based on said sequence of symbols and said proof, a leaf-level digest;
   performing a series of iterative hash operations using said proof and said leaf-level digest to generate a root value; and
   comparing the root value to the retrieved root for the another device.

In some embodiments, the proof is generated by a method according to the second aspect.

In a fourth aspect, the present disclosure relates to a connected device comprising: at least one processor; and machine-readable storage comprising instructions for causing the at least one processor to perform a method as disclosed herein.

In a fifth aspect, the present disclosure relates to a networked system comprising a plurality of connected devices, wherein each of a subset of the connected devices is configured to carry out a method according to the first or second aspects of the disclosure, and/or is configured to carry out a method according to the third aspect of the disclosure.

The networked system may be an industrial control system or a smart grid.

In a sixth aspect, the present disclosure relates to non-transitory computer readable storage having instructions stored thereon for causing at least one processor to carry out one or more of the methods disclosed herein.

### BRIEF DESCRIPTION OF THE DRAWINGS

Some embodiments of message authentication methods, systems and devices, in accordance with present teachings will now be described, by way of non-limiting example only, with reference to the accompanying drawings in which:

FIG. 1 is a block architecture diagram of an example system of connected devices in which embodiments of the present disclosure may be implemented;

FIG. 2 is a flow diagram of an example message authentication method;

FIG. 3 shows a bit-stream example over a Merkle hash tree as used in embodiments;

FIG. 4 is an example of a tri-leaf tree as used in embodiments;

FIG. 5 shows pseudo-code of an example algorithm for building a tri-leaf tree;

FIG. 6 shows pseudo-code of an example algorithm for batch generation of a proof;

FIG. 7 shows pseudo-code of an example batch verification algorithm; and

FIG. 8 is an example architecture of a security device for implementing message authentication methods according to embodiments.

### DETAILED DESCRIPTION

In general terms, embodiments of the present disclosure provide a solution for fast message authentication. In some embodiments, security devices may be implemented as bump-in-the-wire (BITW) devices for various types of industrial control systems without requiring major changes in existing devices or infrastructure. For example, a BITW device may be implemented in an intrusive (serial) manner, in which it intercepts traffic in the network, or in a non-intrusive (parallel) manner, in which it does not intercept traffic, but merely receives a copy of a message for monitoring and provenance verification purposes.

In other embodiments, the message authentication protocol of the present disclosure may be implemented natively in connected devices in a networked system, for example as software or firmware or a combination of these.

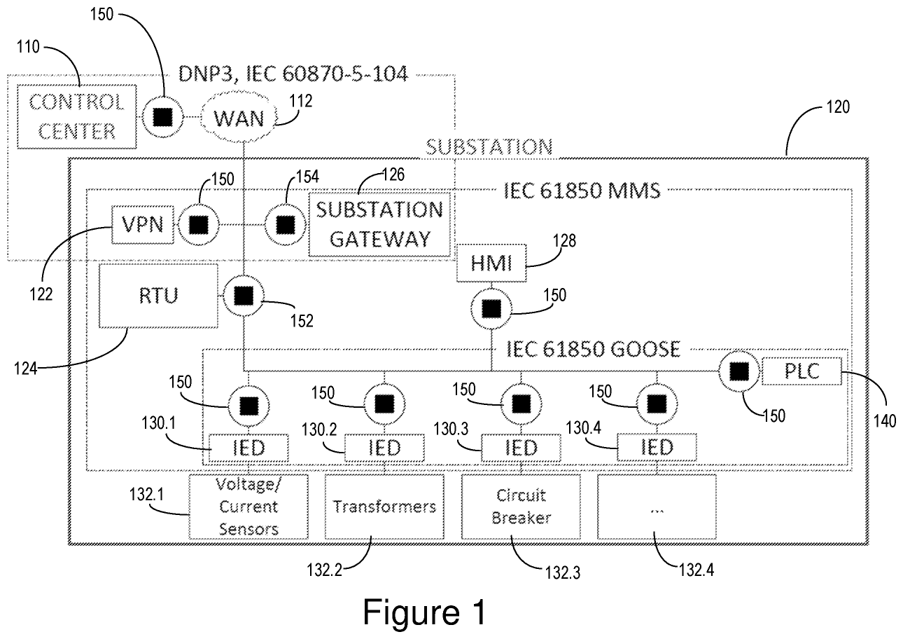

FIG. 1 shows an example of a system 100 of connected devices in which embodiments of the present disclosure may be implemented. The example illustrated in FIG. 1 is a smart grid system in which a plurality of security devices are connected as BITW devices to authenticate messages originating from connected devices of the smart grid system, such as PLCs 140, RTUs 124, and so forth. However, it will be understood that this is simply illustrative and not limiting. Embodiments may be implemented in a number of other contexts, including in Internet-of-Things (IoT) systems, and implementations need not be via BITW devices (whether these be implemented in intrusive or non-intrusive fashion), but could instead be via software or firmware as mentioned above. Accordingly, it will be understood in the discussion below that a “security device” may itself be one of the connected devices of the system 100, or be incorporated into one of the connected devices of the system 100 (e.g., via one or more hardware, software and/or firmware components).

A smart grid system 100 may include a control centre 110 and multiple (possibly thousands of) substations in the field. For clarity and ease of explanation, FIG. 1 shows a single substation 120, connected to the control centre 110 via wide-area network (WAN) 112, but it will be appreciated that many such substations may be connected to the control centre 110.

As shown in FIG. 1, the substation 120 may use standardised technologies like IEC 60870-5-104 or DNP3.0 for telecontrol and IEC 61850 for substation automation.

Within the substation 120, intelligent electronic devices (IEDs), four examples 130.1 to 130.4 of which are shown, serve as the communication end points. They are responsible for operating on physical power system devices. For example, IED 130.1 operates on one or more voltage/current sensors 132.1, IED 130.2 operates on one or more transformers 132.2, and IED 130.3 operates on one or more circuit breakers 132.3. Realtime communication among the IEDs is crucial for automated protection.

The substation 120 also includes one or more Programmable Logic Controllers (PLCs) 140. PLCs 140 are in charge of automated control based on various power grid measurements. The substation 120 also includes a substation gateway 126 that may perform protocol translation, e.g., between IEC 60870-5-104 and IEC 61850. Substation 120 may also include a human machine interface (HMI) 128 that enables a human operator to observe, and potentially manually override, the operation of individual components of the substation 120, such as actuators or other process control devices. Further, substation 120 may include one or more remote terminal units (RTUs) 124 that acquire data from, and transmit control signals to, components such as PLC 140 and IEDs 130.1 to 130.4. In order to enable remote maintenance, by grid operators or device vendors, virtual private network (VPN) devices 122 connected to the public network 112 may also be deployed.

Each of the connected devices (IEDs 130.1-130.4, PLC 140, VPN 122, RTU 124, substation gateway 126, HMI 128) of the substation 120 may be considered to be a communication node of the system 100, since each is capable of receiving data from, and/or transmitting data to, at least one other connected device in the system 100. In some embodiments, at least a subset of connected devices may themselves be security devices. For example, connected devices such as RTU 124 or HMI 128 may be configured as security devices that receive network traffic passing from other connected devices, and apply one or more cryptographic operations to data derived from the network traffic, according to methods disclosed herein. Where a connected device, such as IED 130.1, does not itself have cryptographic functionality, a security device 150 may be attached thereto, or may otherwise be placed in a communication path between the IED 130.1 and other connected devices in the system 100, such that messages originating at the IED 130.1 can be used by the security device 150 to generate cryptographic evidence to verify the provenance of the messages.

A smart grid system such as the system 100 may implement a variety of communication models, some of which involve only a single hop between a source and a destination. For example, in IEC 61850-compliant substations, Status Update in Substation, Automated Control in Substation, and Protection to Switchgear are done using the GOOSE (Generic Object Oriented Substation Events) protocol. These are publisher-subscriber-type communications using multicast. In other cases, multiple entities (hops) are involved. For instance, in SCADA Control/Monitoring, commands from a control centre to a field device in a low-voltage substation may be mediated by devices in a high-voltage substation. Note that, for such communications, when protocol translation is involved, the substation gateway 126 may work as a source of the translated messages.

Another complicated communication model is the Reporting by Field Devices, where measurements from PLCs 140 or IEDs 130.1 to 130.4 are first sent to the substation gateway 126 or RTU 124, which may perform protocol translation and/or message aggregation before forwarding them.

The latency requirements specified by public guidelines such as those provided by IEEE and the US Department of Energy vary depending on the use case. Of note, communication within substations has very stringent delivery latency requirements. In particular, Protection to Switchgear requires very short latency (below 2 ms according to IEEE guidelines).

Accordingly, embodiments of the present disclosure provide a device, method and system for securing systems of connected devices, in a manner which can meet stringent latency requirements.

A plurality of security devices 150 that implement the method may be provided in the system 100 of connected devices. For example, in some embodiments, each key communication node (e.g., a SCADA master, IEDs, PLCs, substation gateways, etc.) may have a security device 150 connected thereto, as shown in FIG. 1, such that all messages (or copies thereof) that are sent or received by the key communication nodes of the system 100 are intercepted (or otherwise obtained) by a security device 150 that implements the security method. In other embodiments, security devices 150 may be attached only at critical junctures of the system 100, i.e. may not be attached directly to one of the connected devices, but may be placed at points of the network so that they can intercept or otherwise obtain network traffic to generate cryptographic evidence that can be used for provenance verification by other security devices 150 that are “downstream” along the communication path. The placement and functionality of the security devices 150 enables systematic verifiability of the provenance information as will be described in further detail below. In some embodiments, the key communication nodes themselves may perform the functions of security devices 150.

In some embodiments, transparent, bump-in-the-wire (BITW) devices 150 can be incorporated into existing systems 100. Accordingly, in such example implementations, while legacy, existing ICS devices can send and receive messages in an as-is manner, added BITW devices 150 intercept (or otherwise obtain) messages and provide extra protection and verification without affecting the endpoints. For example, a BITW device 150 may be connected in series with two connected devices, such that a message passing from a first connected device to a second connected device is intercepted by the BITW device 150 such that the BITW device 150 may perform one or more cryptographic operations on the message before it reaches the second connected device. In another example, a BITW device 150 may be connected in parallel, such that the message passes from the first to the second connected device as normal, but a copy of the message also passes to the BITW device 150 for performing one or more cryptographic operations thereon.

In some embodiments, a security device 150 at the sender side (also referred to herein as the prover) intercepts (or otherwise obtains, e.g. by receiving copies of messages) and “wraps” messages for additional security, and a security device 150 at the receiver side (also referred to herein as the verifier) performs verification and security policy enforcement and then “unwraps” and forwards the original message to the target device.

For example, with reference to FIG. 1, IED 130.1 may transmit messages to RTU 124 that contain data relating to operation of voltage/current sensors 132.1, during normal operation of the substation 120. In this example, the IED 130.1 is the sender device and the RTU 124 is the destination device. In some embodiments of the present disclosure, the IED 130.1 and RTU 124 each have a security device 150 connected thereto. In some embodiments, the functionality of a security device 150 may be incorporated into the RTU 124 (e.g., via software or firmware installed on the RTU 124). The security device 150 connected to IED 130.1 intercepts or otherwise obtains the message (or a copy thereof) from IED 130.1 and generates a cryptographic proof that is based on pre-computed signatures. The cryptographic proof can be used by the security device 150 that is attached to (or is part of) RTU 124 to perform verification and security policy enforcement, forwarding the message to the RTU 124 if these checks are successful.

In some embodiments, the system 100 may include a redundancy mechanism to handle possible failures of security devices 150. For example, in existing deployments of smart grids, a critical smart grid device often has a hot standby system, and/or itself may have multiple network interfaces. Accordingly, redundant security devices 150 can be connected to the hot standby devices and to each of the standby interfaces of a critical device. Hence, the failure of a single security device 150 can be tolerated. The degree of redundancy may be decided based on the criticality of the associated smart grid devices. Such an architecture may also include a watchdog mechanism that monitors the availability of the security devices 150, e.g., based on timeout, to enable automated fail-over. For example, the watchdog mechanism may be implemented at control centre 110 and/or within individual substations 120.

Mediation by security devices 150 can be done selectively based on, for example, types of messages, nature of the target devices, and so forth. In this way, the security devices may be configured to have minimal impact on system throughput.

To meet the stringent latency requirements mentioned above, when a security device 150 initiates or verifies a message, public-key based solutions such as DSA and RSA cannot be used. Accordingly, embodiments of the present disclosure are based on pre-computed signature data that is generated during a setup phase, asynchronously with the sending and signing of messages by security devices 150 in the system 100. When a message is received by a security device 150, it can generate a cryptographic proof by performing computationally inexpensive retrieval of the pre-computed signature data based on the message content, rather than expensive operations such as modular exponentiation, elliptic curve scalar multiplication, or cryptographic pairing. The retrieved signature data is used to generate the cryptographic proof, which is then sent to another security device 150, which may act as a verifier, verifying the cryptographic proof using public metadata distributed during the setup phase. Accordingly, the present disclosure provides an “all-offline” signature method that enables implementation of bump-in-the-wire security devices that improve the security of a networked system (such as the system 100) while still enabling time-stringency criteria to be met.

In the following discussion, the all-offline signature method will be illustrated in the context of a single signer communicating with a single verifier. However, it will be appreciated that any security device 150 in the system 100 may act as both a signer (when it signs messages for verification) and a verifier (when it receives signed messages for verification), depending on the context.

Embodiments of the all-offline signature method may comprise two phases. In the first, offline phase, the signer may generate a specific hash tree (referred to herein as a tri-leaf tree) that covers a limited number of bits for future messages, and sign its root. There is one leaf node in the tree per bit. For instance, a tree of size 1000 supports ten messages of size 100 bits, or twenty messages of size 50 bits. The signed root then is shared with all the possible destinations, where it is verified and stored. This root value can be used to verify multiple messages in the future and the number of messages to be covered depends on the tree size. In the second phase, after the message is chosen, the signer generates a proof from the hash tree that can be verified with the root value. The proof generation comprises collecting values from the tree, packing them and sending them to the destination together with the message. The destination then recalculates the root using the values from the tree and if the root values match, the destination is satisfied that the message is intact and has been sent by the source that has signed the root. The signed root may be periodically refreshed by the signer, before it expires or before all the values in the tree are consumed.

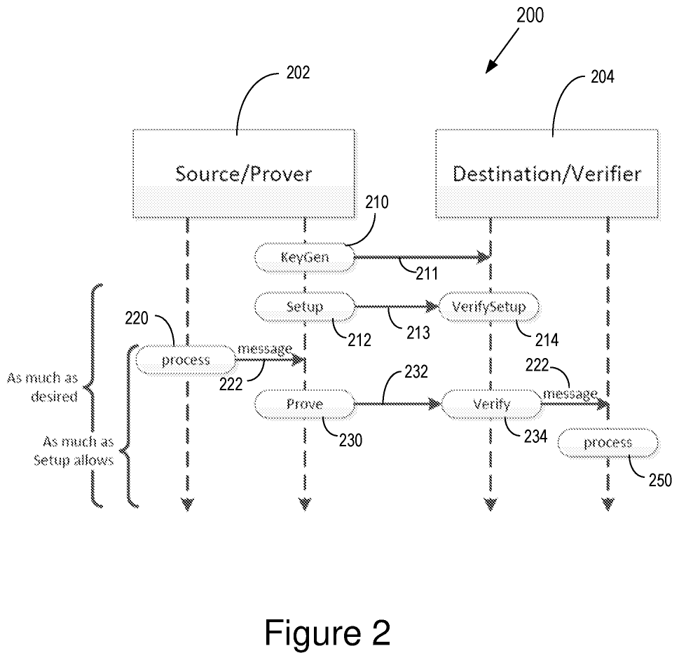

Referring now to FIG. 2, a high-level process flow for an example method 200 of message authentication according to some embodiments of the present disclosure is shown.

In the method 200, a source/prover 202 communicates with one or more destinations/verifiers 204.

For example, a source may be a connected device, such as RTU 124, that is executing a process 220. The process 220 emits messages 222 for which a cryptographic proof is generated by a prover. For example, the prover may be a security device 152 that is connected to, or otherwise in networked communication with, the RTU 124 (FIG. 1). That is, RTU 124 and security device 152 may be considered to collectively be a source/prover 202. In some embodiments, the proof may be generated by the source itself, i.e. the source and prover may be the same entity. For example, RTU 124 may not have security device 152 connected thereto, but may instead generate the proof for message 222 itself.

A destination may be another connected device, such as substation gateway 126, that is executing another process 250. For example, the process 250 may expect to receive messages 222 from the source 202. The destination may be connected to, or may also be, a verifier that receives proofs from the source 202 for messages 222 and verifies them.

For example, a substation gateway 126 executing process 250 may be connected to a security device 154 (FIG. 1) that acts as a verifier. That is, the substation gateway 126 and security device 154 may be considered to collectively be a destination/verifier 204. Alternatively, the destination and verifier may be the same entity (e.g., the substation gateway 126 verifies the proof for message 222 itself).

In the following discussion, for ease of explanation, it will be assumed that the source is also the prover, and that the destination is also the verifier. However, it will be appreciated that in some embodiments, such as a bump-in-the-wire implementation, the prover and verifier functions may be delegated to security devices 150, 152, 154 that are in communication with the source and the destination.

The source 202 seeks to prove its identity and the authenticity of its messages to the destination 204. The source 202 has no prior information on the content of the future messages and the source 202 does not want to do any expensive operations (such as modular exponentiation, elliptic curve scalar multiplication or cryptographic pairing) after the message is selected.

In a first phase of the method 200, a KeyGen process 210 is executed by the source 202. In the KeyGen process 210, KeyGen(1ⁿ)→(privₖ, pubₖ) is a probabilistic algorithm algorithm run by the source 202, which takes as input a security parameter k, and outputs a private key privₖ and a public key pubₖ. The source 202 stores the private key, and sends the public key to the destination 204, at step 211.

The source 202 also executes a Setup process 212. Setup(privₖ,length)→{mdₚᵣᵢᵥ,md_{pub}, s} runs offline, before any messages are selected. Setup process 212 generates two types of metadata (for future messages)—private metadata mdₚᵣᵢᵥ to be kept at the source 202, public metadata md_{pub} to be published to the destinations 204 (at step 213), and the signature s for the public metadata. The length is the maximum content that can be verified at the destination 204 using the generated metadata.

VerifySetup(pubₖ, md_{pub}, s)→{accept/reject} is a process run at step 214 by the destination 204. The destination 204 verifies and stores the public metadata md_{pub}. At this point, the first phase of the method 200 is complete.

In the second phase, the source 202 (or a separate device acting as a prover) is ready to sign messages 222 that are emitted during the course of a process 220 executing at the source 202. To do so, it executes a Prove process 230. Prove(message, mdₚᵣᵢᵥ, state)→{proof} is executed after the message is generated, to generate the proof of message authenticity and source identity. As input, it takes the generated message, the private metadata that has been kept at the source 202, and the state of the private metadata, since the same metadata can be used for multiple future messages. For example, the state of the metadata may be indicative of a position of a first unused leaf in a tri-leaf tree, as will be discussed in further detail below. In the present embodiments, the Prove process 230 does not perform any computationally expensive operations.

At step 232, the source 202 sends the message and the proof to the destination 204, which performs, at step 234, a Verify process. Verify(message, proof, md_{pub})→{accept/reject} takes the public metadata, the proof and the message content sent by the source 202 and outputs a result of accept or reject. An output of accept is an indication that the source is legitimate and the message has not been tampered with. If so, then the message 222 is accepted and can be passed to process 250 executing at destination 204. Accordingly, the only interruption to the normal messaging flow is the source/prover 202 generating the proof at 230, and the destination/verifier 204 verifying the proof at 234.

Some specific examples of message authentication processes consistent with FIG. 2 will now be described.

In one embodiment suitable for short messages, a Merkle Hash Tree (MHT) may be used to convert a one-time signature scheme (such as Lamport OTS or Winternitz OTS) into a many-time signature to sign a number of messages with a single public key. In this technique, known as Merkle Signature Scheme (MSS), after generating the key pairs for an OTS, the source 202 builds a tree on the hash of the OTS public keys and obtains a root value. This root is called the public key of the MSS and is shared with the destination 204. MSS allows the use of this public key a number of times equivalent to the number of leaves in the tree. However, in the original MSS, the OTS public keys are used to authenticate arbitrary size messages, by reducing each message to a digest (256-bit for SHA-256). In this embodiment, a tree'd OTS is modified to benefit from messages smaller than 256 bits, by using a short message directly, without the first step of calculating its digest. This allows MSS to achieve faster setup and verification times as well as a lower communication overhead. If the message size is variable, this tweak requires the source 202 to choose the OTS key size for the largest message to be signed. Note that, the OTS key size directly affects the computations required in all steps. Therefore, while MSS benefits from small message size thanks to this tweak, it still does not support variable message size as targeted in other embodiments.

Since all information at the leaf level nodes is not secret, an adversary can also calculate every part of this tree. Therefore, a nonce is added for each leaf level node to be concatenated to a message that the node corresponds to, before its hash is calculated. The source 202 then signs the root and sends the signature and the root hash value to the destination 204 prior to the arrival of any message (Setup 210). The signature is verified at the destination 204 using the public key provided by source 202, before storing the root hash value (VerifySetup 214). When the message is selected, the source 202 reads the tree from memory and collects all the information necessary from the tree starting from the nonce associated with the message (Prove 232). Since an adversary does not know, and cannot guess, the nonce value—given that it is an adequately large random value—for a message before it is released, the destination 204 will be convinced that the message has been sent by the same party that has signed the root hash value (Verify 234).

The Merkle hash tree enables fast proof collection time after the message is picked, but the tree size is O(2^{m}) when the message size is m. This can be reduced using the following technique.

As described above, the root of the tree may be signed at the Setup phase 212 and shared with the destinations 204, where it is verified (VerifySetup 214). However, instead of generating the tree for every message at the leaf level nodes, the source 202 may generate the tree having a bit of a message at each leaf, and selecting a nonce per possible value of the bit. Hence, the tree keeps at least 2 nonce values per leaf node.

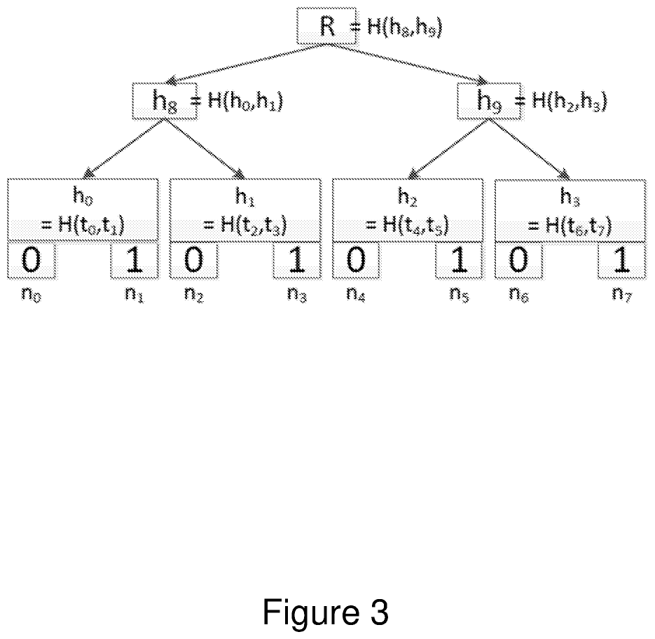

With reference to FIG. 3, an example proof will now be described for messages [1,0] and [0,1] consecutively. A proof generated from an authenticated data structure such as a Merkle tree consists of the values that are required to calculate the root hash value. For instance, the proof for [1,0] is {n₁, n₂, to, t₃, h₉} (noting that tᵢ=H(nᵢ) where H is a hash function) and the proof for the next message ([0,1]) is {n₄, n₇, t₅, t₆, h₈}. Thanks to these proofs, a probabilistic polynomial time adversary cannot flip any bits of the messages without knowing the nonce values that have not been used, otherwise we can break the collision resistance of the employed hash function.

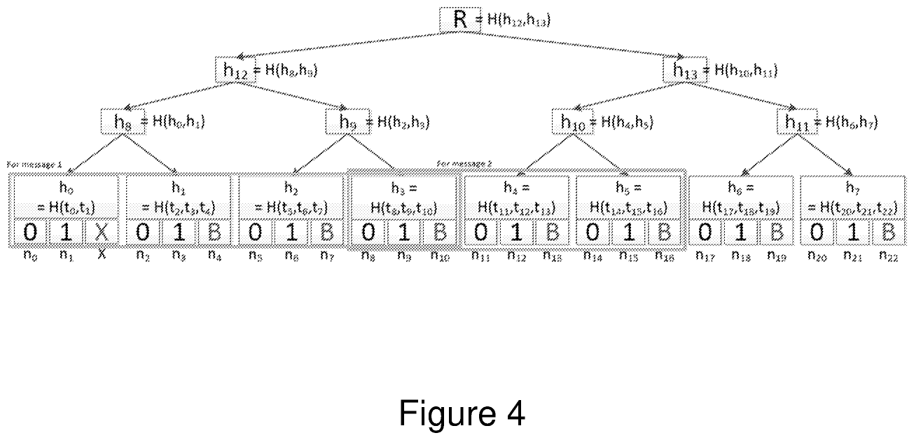

To overcome potential security flaws, instead of having 2 nonce values, 3 nonce values can be stored per leaf node. The new addition corresponds to a “BREAK” symbol (B), and is used as a separator between messages. The modified version of the Merkle tree is shown in FIG. 4. Given the 3rd nonce value, now the source 202 can generate a proof as such [1,0,B]. Since the adversary cannot generate a proof using an unused nonce, at least some potential attacks are then void.

To further improve security, to prevent attacks in which an adversary crops messages or deliberately drops them, in some embodiments messages can be encapsulated by starting and ending every message with a “BREAK”, for instance [B,1,0,B] and [B,1,13]. Messages may share the same leaf node for B in their corresponding proofs. Preferably, only one nonce per leaf is used in a proof, since otherwise it may not be possible to counter merge attacks. Therefore, the nonce for the break and a nonce for either 0 or 1 should not be used from the same leaf node.

Accordingly, some embodiments comprise generating a tri-leaf tree, which is a static tree where the size may be preset according to the message size and the message frequency of the communication model that the message authentication method is to be applied to. The tree is only used to generate proofs, and is immutable. The build complexity is 0(n), where n is the number of bits the data structure will support for future messages.

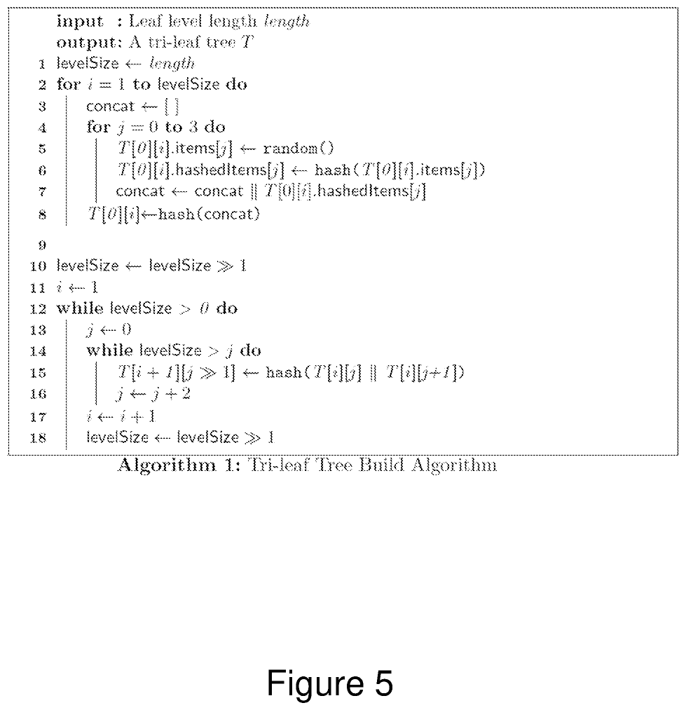

The notation used in the following sections, and in FIGS. 5 to 7, is set out in the Table below.

| | |
|---|---|
| . | Access operator |
| ← | Assignment operator |
| ∧ | Bitwise AND operator |
| ⊕ | Bitwise XOR operator |
| << | Bitwise left shift operator |
| ¬ | Bitwise inversion operator |
| >> | Bitwise right shift operator |
| ∥ | Concatenation |
| ? : | Conditional (ternary) operator |
| [ ] | Empty list |
| = = | Equality check |
| pl | Pointer to track the leftmost node |
| pr | Pointer to track the rightmost node |
| p | Pointer to traverse the proof |

For clarity and in order to achieve a cleaner notation in pseudo-code, the digest of a node is written\read without an access operator, i.e. T[i][j] ←0 means the digest of the node at level i offset j is assigned 0. Other fields of a node (items, hashedItems) are accessed via access operator.

Referring to Algorithm 1 in FIG. 5, the build procedure is initiated at Lines 2-8 by generating the nonce values of the leaf nodes. Once a leaf node has all of its nonce values generated, the collective digest of the leaf node is calculated.

Lines 12-18 calculate the digests of the upper level nodes based on the digests of their children. Note that this implementation is correct if a complete binary is to be generated.

Accordingly, some embodiments may be limited to complete binary trees by imposing the condition that length is some power of two. It will be appreciated that generalizations are possible, though this is not necessary for the purposes served by tri-leaf trees.

Referring again to FIG. 2, an example of a message authentication method using a tri-leaf tree will now be described.

At step 210, a KeyGen process is performed, KeyGen(1ⁿ)→privₖ,pubₖ. This algorithm is equal to the key generation of the signature scheme we employ. Since we only use the signature scheme for signing the root periodically, this algorithm can be substituted with others. Having the security parameter as input, this algorithm generates a private key and its corresponding public key (privₖ, pubₖ). The source 202 stores the private key, and sends the public key to the destination 204.

At step 212, a Setup process is executed by source 202, setup(privₖ,length) {mdₚᵣᵢᵥ,md_{pub},s}. The inputs are privₖ, which was stored at step 210 at the source 202, and length, which is a preset value. This procedure may call Algorithm 1 to generate the tri-leaf tree of size length. Then it signs the tree's root with the signature scheme using privₖ The outputs are the tri-leaf tree as the private metadata, its root as the public metadata and the root's signature to be verified by the destination 204 before storing the public metadata.

At step 214, destination 204 executes a VerifySetup process: VerifySetup(pubₖ,md_{pub},s)→{accept/reject}. Using the public key stored during KeyGen 210, the destination 204 verifies the public metadata with the signature scheme's verify procedure. If it accepts, then the public metadata is stored.

At step 230, the source 202 executes a Prove process: Prove(message, mdₚᵣᵢᵥ, state)→{proof}. This procedure collects necessary information corresponding to the message to allow the destination 204 to calculate the root digest value. This may correspond to calling Algorithm 2 with the tri-leaf tree (private metadata), its state and the message as inputs, where state stores the location of the last used leaf node. Finally, Algorithm 2 outputs the proof vector in a way that can be interpreted by the Verify algorithm 234. The runtime is O(m+log l) memory read operations, where m is the message length and l is the length given to Setup as input.

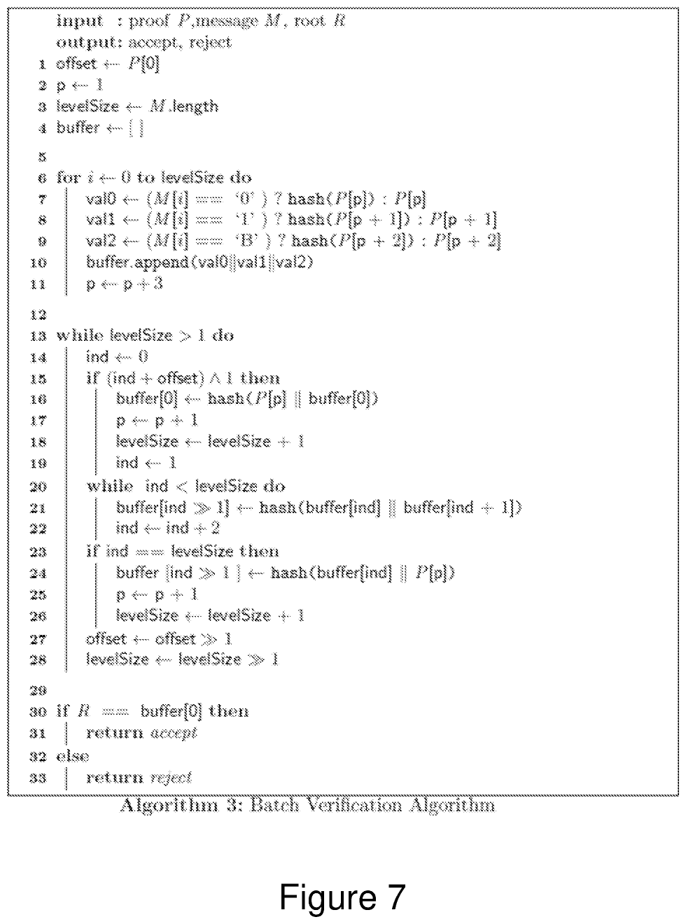

At step 234, the destination 204 executes a Verify process; Verify(message, proof, md_{pub})→{accept/reject}. This procedure takes the message and its proof as input and may call Algorithm 3 (FIG. 7) with the proof, the message and the public meta-data as inputs. This procedure verifies the message if Algorithm 3 returns accept. The runtime is O(m+log I) hash calculations and storage complexity is 0(m), where m is the message length and I is the length given to Setup as input.

Examples of the Prove and Verify algorithms will now be described in further detail. In some embodiments, the Setup/VerifySetup algorithms discussed above may run periodically and provide the root digest to the verifier (destination 204). Accordingly, in the below discussion it will be assumed that the root digest is known to the verifier and that it is fresh.

In the data structure, the proof for one single leaf node contains, other than the node that is proven, the siblings of the nodes that are on the path from the leaf to the root. FIG. 4 illustrates an example tri-leaf tree. The said path for the leaf node h3 is [h3; h9; h12]. Therefore, the proof for the leaf node h3 contains [h2; h8; h13]. However, in the presently described embodiments, the proofs are generated for multiple leaf level nodes since even for a message of length one will require a proof for three leaf level nodes (due to the break symbol at the start and end) as discussed above.

Some embodiments may comprise a batch proving process. In the present context the proofs on a tri-leaf tree are generated for a set of consecutive leaves. Leveraging on this feature, an enhanced proof generation algorithm may be implemented for batch operations. The proof in this embodiment is the union of the smaller siblings of the leftmost leaves and the larger siblings of the rightmost leaves at each level. The other nodes in between can be calculated with the other information at hand, therefore do not need to be included in the proof.

In the following, we present the generation of the proof for the set of nodes S={h3; h4; h5; h6} (in FIG. 4). The proof for the leftmost leaf node h3 is [h2; h8; h13] while the proof for the rightmost leaf node h6 is [h7; h10; h12]. A node is said to be a left\right sibling if it has a smaller\larger offset than the offset of its sibling. In the proof for the leftmost leaf node, h2, h8 are left siblings, while in the proof for the rightmost leaf node, h7 is the only right sibling. Therefore, the proof for the set S is [h2, h7, h8].

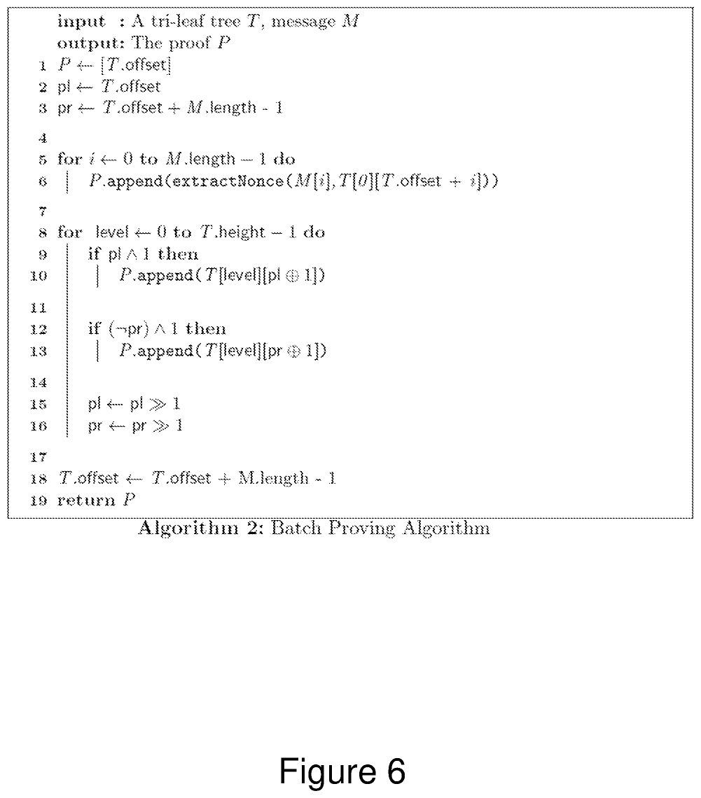

In Algorithm 2, as shown in FIG. 6, the procedure can be implemented with bit operations, since bit operators are performance-friendly. It will be appreciated that every node on a binary tree can be identified with bit addresses. Starting from the root node, these addresses indicate which child of a node should be followed in order to reach a particular node. For instance, the bit addresses of h9, h3 in FIG. 4 are [01], [011] respectively. Furthermore, given a node with bit address A, its parent and siblings have bit addresses A» 1; A ⊕1 respectively. A node has a left sibling if and only if the least significant bit of its bit address is 1 and has a right sibling otherwise, except if it is the root.

When a node that is not at the leaf level is added to the proof, its stored digest is added. However, for the proof of a leaf node, an information sufficient to calculate that leaf node is added to the proof. The information contains one nonce value chosen according to the symbol being transmitted, i.e. (0, 1 or B), and two hashed nonce values that are needed to calculate the digest of the leaf node. For instance, to generate a proof for the symbol 1 when the offset is 3 (at h3) the prover adds n9 and hashed nonce values t8, t10 to the proof. If the symbol is B, then t8, t9 and n10 are to be added. The extractNonce routine in Algorithm 2 (Line 6) extracts the information accordingly.

In Algorithm 2, the proof is generated for the leftmost and the rightmost nodes via tracking them back to the root with pointers pl, pr respectively. In Lines 2 and 3, these pointers are initialized accordingly. Lines 9 and 10 check if pl has a left or right sibling and if its sibling is to be included in the proof or not. Lines 12 and 13 repeat the process for pr. Lines 15 and 16 update the leftmost and rightmost nodes for the processing of the next level. Line 18 prepares the tree for forthcoming messages by advancing to the next part of the leaf level of the tree.

Some embodiments provide a batch verification process. In this procedure, the verifier (destination 204) attempts to calculate the root of a tri-leaf tree based on the proof generated by the prover (source 202). A pointer p points to the index to be processed starting from 1. In Algorithm 3, shown in FIG. 7, Lines 6-11 calculate the leaf digest using the three values that have been generated by the extractNonce routine for the leaf level items in the proof. Once this process is done, a set of consecutive leaves is determined, whose offset on the tree is also known. Taking these values as base, the subsequent levels are reconstructed. It is worth noting that memory of size proportional to the message length is used, and that the same memory buffer is used to overwrite the lower level values, which are single-use, so that the space complexity remains 0(m), where m is the message size. Line 15 checks if the leftmost node in the current level has a left sibling in the tree. If it has, then the sibling of the leftmost node should be pointed to by the p in the proof P. After the sibling is fetched, the leftmost element of the next level is calculated at Line 16. At Lines 20-22, the remaining pairs of nodes in the buffer are used to calculate the next level. The occurrence of a left-over after all pairs are processed implies that the rightmost node in this level has a right sibling and p is pointing to it. In that case, the next element of the proof P is fetched and used in the calculation of the rightmost element of the next level. Lines 23-26 handle this case. The whole process continues until the size of the level reduces to 1. Finally, Lines 30-33 compare the calculated root and the provisioned root and Algorithm 3 outputs accept if they are equal.

If the verifier holds the state of the previous verified proofs, then the left siblings in the proofs are not required to be sent over the network. The first proof does not contain left siblings. For the rest, one previous proof includes the left sibling values.

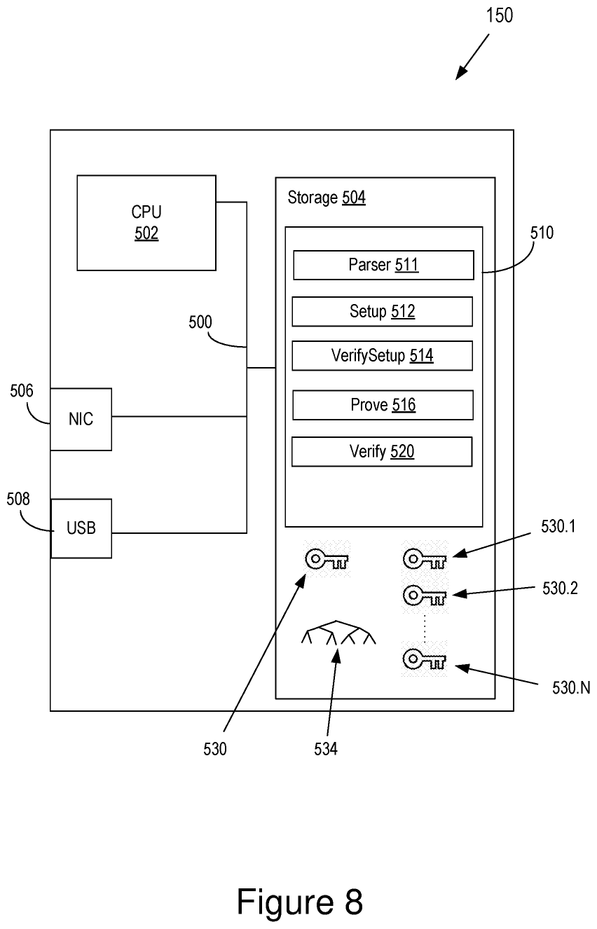

FIG. 8 shows an example high level architecture of a security device 150 according to certain embodiments. In some embodiments, the security device 150 may be implemented on a BeagleBoard platform, such as BeagleBoard-X15. The security devices 152 and 154 shown in FIG. 1 may have a similar architecture to the security device 150 of FIG. 8. As mentioned above, in some embodiments, the functions of the security device 150, 152 or 154 may be performed by key communication nodes of the system 100, such as HMI 128, PLC 140, VPN 122, RTU 124, or substation gateway 126. Accordingly, it will be understood that part or all of the processes described as being performed by security devices 150, 152, 154 may be implemented in software or firmware instructions that are executed by one or more processors of such communication nodes.

The security device 150 comprises at least one processor 502 that is in communication with at least one storage medium 504. The security device 150 also comprises at least one network interface component 506, such as an Ethernet interface, and optionally may comprise other interface components, such as USB interface 508. The at least one processor 502 may be in communication with storage 504, NIC 506 and USB 508 via a bus 500, for example.

The at least one storage medium 504 stores programming instructions of one or more software components or modules 510 to cause the at least one processor 502 to execute the processes and/or methods of the present disclosure. At least parts of the software modules 510 could alternatively be implemented as one or more dedicated hardware components, such as application-specific integrated circuits (ASICs) and/or field programmable gate arrays (FPGAs).

The at least one storage medium 504 also stores cryptographic data and functions for facilitating execution of the processes and/or methods of the present disclosure. For example, storage medium 504 may store a private key 530 for the security device 150.

Security device 150 may generate a plurality of derived keys 532.1, 532.2, . . . , 532.N for N other security devices 150 in the system 100, each of which is a destination node from the perspective of the security device 150, as described above. Security device 150 may also generate and store a Merkle hash tree and/or a tri-leaf tree 534 as described above. These may also be stored in storage medium 504. In some embodiments, keys 530 and 532.1, . . . , 532.N and tree 534 may be stored in a secure area of the storage medium 504, a separate secure storage medium, and/or in a Trusted Execution Environment (TEE) of a processor 502. In TEE-based implementations, at least some cryptographic functions may also be stored in the TEE for safe execution therein.

The security device 150 may comprise a plurality of standard software modules (not shown), including an operating system such as Linux, and one or more libraries that provide standard networking functionality. Additionally, the security device 150 may comprise the following modules:
A packet parser 511 that is responsible for transparently intercepting or otherwise obtaining (e.g. copies of) packets that are incoming into or outgoing from the protected device to which the security device 150 is connected. Example implementations may use either iptables (in case IP-based protocols such as IEC 60870-5-104 and IEC 61850 MMS can be handled) or ebtables (for handling of IEC 61850 GOOSE), along with NFQUEUE to intercept or otherwise obtain packets of interest, extract the accompanying proof if any, and pass this to one or more other of the modules 510 for further processing or analysis, such as verify module 520. The parser 511 may also receive outputs from the other modules and compile an outgoing packet for transmission to other security devices 150 in the system 100. If the proof is not valid or any other issue is found, the packet may be dropped.
A Setup module 512 that generates private keys 530, derived keys 530.1, . . . , 530.N, and trees 534, and distributes public metadata including the derived keys 530.1, . . . , 530.N, the root of the tree 534, and the root signature, to other security devices 150.
A VerifySetup module 514 that verifies the public metadata.
A Prove module 516 that signs a message that is passing though the physical device that the security device 150 is attached to, as described above.
A Verify module 520 that checks the authenticity of a proof associated with a message intended to be received by a physical device to which the security device 150 is attached, and either accepts or rejects the evidence, as described above.

As shown, the modules 510 are implemented in the application layer, but it will be appreciated that in other embodiments, it is possible to implement one or more of the modules 150 in the kernel space for better performance. Further, one or more of the modules 510 may alternatively be implemented in a TEE of processor 502.

The boundaries between the modules and components in the software modules 510 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes performed by the security device 150 may be executed by a module (of software modules 510) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The security device 150 normally processes information according to a program (a list of internally stored instructions such as a particular application program and/or an operating system) and produces resultant output information, for example via input/output (I/O) devices such as NIC 506. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-13. (canceled)

14. A networked system comprising a plurality of connected devices configured to carry out a method of provisioning a message authentication protocol in the networked system, the method comprising, by at least one of the connected devices:
generating a private key and a public key;
transmitting the public key to each other connected device;
generating, by a sequence of hash operations using the private key, a hash tree, wherein each leaf node of the hash tree can have two or more values, each of the two or more values being associated with a respective nonce value, and wherein each leaf node has a hash computed from the concatenation of the respective nonce values;
signing a root of the hash tree with the private key; and
transmitting the root and the root signature to each other connected device.

15. A networked system according to claim 14, wherein each other connected device validates the root signature.

16. A networked system according to claim 14, wherein each leaf node of the hash tree can have three values, and wherein each of the three values comprises a nonce corresponding to 0, 1, and a break value.

17. A networked system according to claim 14, wherein the at least one of the connected device repeats the method after consumption of a predetermined number of the nonce values, and/or before a predetermined expiry time.

18. A networked system comprising a plurality of connected devices configured to carry out a method of providing authentication information for a message, the method comprising:
at one of the connected devices that stores a hash tree in which each leaf node can have two or more values, each of the two or more values being associated with a respective nonce value that is stored in association with the hash tree, each leaf node having a hash computed from the concatenation of the hashes of the respective nonce values:
determining an offset of a leaf node which has not already been used;
determining a symbol sequence of the message, each symbol in the sequence having one of said two or more values;
determining a proof by:
for each symbol in the sequence, retrieving a corresponding nonce value of a corresponding leaf node based on the value of the symbol, and hashes of the other respective nonce values for the corresponding leaf node; and
traversing the hash tree to retrieve hashes of siblings of nodes on a path between the leaf node and a root of the hash tree;
wherein the proof comprises a combination of, for the respective symbols, the corresponding nonce values, the hashes of the other respective nonce values, and the hashes of the siblings on the path between the leaf node and the root; and
transmitting the proof and the message to at least one of the other connected devices.

19. A networked system according to claim 18, wherein each leaf node of the hash tree can have three values, each of the three values comprising a nonce corresponding to 0, 1, and a break value, and wherein the message begins and ends with a break symbol.

20. A networked system according to claim 18, wherein the hash tree is generated by a sequence of hash operations using a private key, wherein each leaf node of the hash tree can have two or more values, each of the two or more values being associated with a respective nonce value, and wherein each leaf node has a hash computed from the concatenation of the respective nonce values.

21. A networked system comprising a plurality of connected devices configured to carry out a method of verifying authentication information for a message, the method comprising:
at a connected device of the connected devices, receiving the message and a proof from another device of the connected devices, the proof being generated according to a hash tree;
retrieving a root and a root signature for the another device; and
verifying the proof by:
determining a sequence of symbols of the message;
determining, based on said sequence of symbols and said proof, a leaf-level digest;
performing a series of iterative hash operations using said proof and said leaf-level digest to generate a root value; and
comparing the root value to the retrieved root for the another device.

22. A networked system according to claim 21, wherein the proof is generated by a networked system comprising:
a plurality of connected devices configured to carry out a method of providing authentication information for a message, the method comprising:
at one of the connected devices that stores a hash tree in which each leaf node can have two or more values, each of the two or more values being associated with a respective nonce value that is stored in association with the hash tree, each leaf node having a hash computed from the concatenation of the hashes of the respective nonce values:
determining an offset of a leaf node which has not already been used;
determining a symbol sequence of the message, each symbol in the sequence having one of said two or more values;
determining the proof by:
for each symbol in the sequence, retrieving a corresponding nonce value of a corresponding leaf node based on the value of the symbol, and hashes of the other respective nonce values for the corresponding leaf node; and
traversing the hash tree to retrieve hashes of siblings of nodes on a path between the leaf node and a root of the hash tree;
wherein the proof comprises a combination of, for the respective symbols, the corresponding nonce values, the hashes of the other respective nonce values, and the hashes of the siblings on the path between the leaf node and the root; and
transmitting the proof and the message to at least one of the other connected devices.

23. A networked system according to claim 21, wherein each of a subset of the connected devices is configured to carry out a method of provisioning a message authentication protocol in the networked system comprising:
generating a private key and a public key;
transmitting the public key to each other connected device;
generating, by a sequence of hash operations using the private key, a hash tree, wherein each leaf node of the hash tree can have two or more values, each of the two or more values being associated with a respective nonce value, and wherein each leaf node has a hash computed from the concatenation of the respective nonce values;
signing a root of the hash tree with the private key; and
transmitting the root and the root signature to each other connected device.

24. A networked system according to claim 23, wherein the system is an industrial control system.

25. A networked system according to claim 23, wherein the system is a smart grid.
